(19) United States
(12) Patent Application Publication
(10) Pub. No.: US 2009/0118842 A1
(43) Pub. Date: May 7, 2009

(54) Manufacturing prediction server

(76) Inventors: David Everton Norman, Bountiful, UT (US); Richard Stafford, Bountiful, UT (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/983,102

(22) Filed: Nov. 6, 2007

(51) Int. Cl. G05B 13/02

(52) U.S. Cl. 700/44

(57) ABSTRACT

In one embodiment, a method for providing predictions pertaining to a future state of a manufacturing facility includes collecting data from various source systems in a manufacturing facility, and generating predictions pertaining to a future state of the manufacturing facility based on the collected data. The method further includes providing the predictions to recipient systems in the manufacturing facility.

### FIELD OF THE INVENTION

Embodiments of the present invention relate generally to managing a manufacturing facility, and more particularly to providing predictions about the future of a manufacturing facility.

### BACKGROUND OF THE INVENTION

In an industrial manufacturing environment, accurate control of the manufacturing process is important. Ineffective process control can lead to manufacture of products that fail to meet desired yield and quality levels, and can significantly increase costs due to increased raw material usage, labor costs and the like.

When managing an automated manufacturing facility, complicated decisions need to be made about what an idle equipment should process next. For example, a user may need to know whether a high-priority lot will become available in the next few minutes. Current Computer Integrated Manufacturing (CIM) systems only provide information about the current state of the facility to aid in making those decisions. Information about what the facility might look like in the future is not immediately available and calculating it on the fly is expensive. This limits the sophistication of decisions that can be made by the CIM system. In particular, producing a schedule for the facility requires this sort of predictive information and calculating it can be a significant portion of the cost of producing a schedule.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates an exemplary network architecture in which embodiments of the invention may operate.

FIG. 2 is a block diagram of one embodiment of a prediction server.

FIG. 3 is a flow diagram of one embodiment of a method for providing predictions pertaining to a future state of an automated manufacturing facility.

FIG. 4 illustrates an exemplary schema of a prediction data model, in accordance with one embodiment of the invention.

FIG. 5 is a flow diagram of one embodiment of a method for repairing existing predictions.

FIG. 6 is a flow diagram of one embodiment of a method for providing subscription services to subscribers.

FIG. 7 illustrates a diagrammatic representation of a machine in the exemplary form of a computer system, in accordance with one embodiment of the present invention

### DETAILED DESCRIPTION OF THE INVENTION

Methods and systems for providing predictions pertaining to a future state of a manufacturing facility are discussed. In one embodiment, a prediction server collects data from various source systems in the manufacturing facility such as a manufacturing execution system (MES), a maintenance management system (MMS), a material control system (MCS), an equipment control system (ECS), an inventory control system (ICS), other computer integrated manufacturing (CIM) systems, various databases (including but not limited to flat-file storage systems such as Excel files), etc. The collected data may include static data (e.g., equipment used by a source system, capability of different pieces of the equipment, etc.) and dynamic data (e.g., current state of equipment, what product is being currently processed by equipment of a source system, the characteristics of this product, etc.).

Upon collecting the above data, the prediction server uses it to generate predictions pertaining to a future state of the manufacturing facility. In particular, the prediction server may predict, for example, a future state of the equipment in the manufacturing facility, the quantity and composition of the product that will be manufactured in the facility, the number of operators needed by the facility to manufacture this product, the estimated time a product will finish a given process operation and/or be available for processing at a given step, the estimated time a preventative maintenance operation should be performed on an equipment, etc.

After the predictions are generated, they are provided to various recipient systems in the manufacturing facility. The recipient systems may include, for example, MES, MMS, MCS, ECS, ICS, scheduler, dispatcher, etc.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals, etc.)), etc.

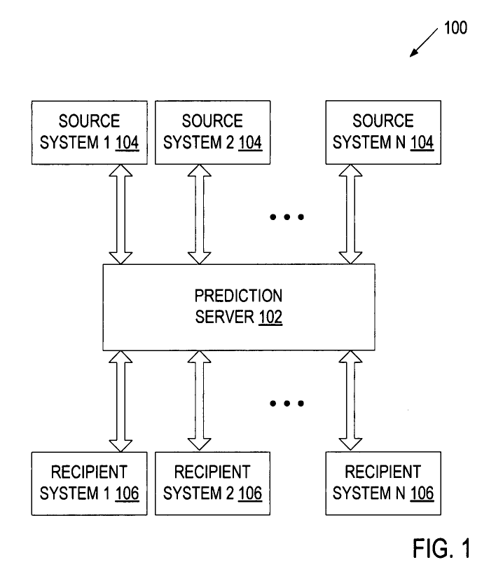

FIG. 1 illustrates an exemplary network architecture 100 in which embodiments of the present invention may operate. The network architecture 100 may represent a manufacturing facility (e.g., a semiconductor fabrication facility) and may include a prediction server 102, a set of source systems 104 and a set of recipient systems 106. The prediction server 102 may communicate with the source systems 104 and the recipient systems 106 via a network. The network may be a public network (e.g., Internet) or a private network (e.g., local area network (LAN)). Two or more of the facility systems may exist on the same machine and not communicate over the network, as they may use other communication protocols like shared memory, or operating system assisted facilities.

The source systems 104 may include, for example, MES, MMS, MCS, ECS, ICS, other CIM systems, various databases (including but not limited to flat-file storage systems such as Excel files), etc. The recipient systems 106 may include some or all of the source systems 104, as well as some other systems such as a scheduler, a dispatcher, etc. The prediction server 102 may be hosted by one or more computers with one or more internal or external storage devices.

The prediction server 104 builds predictions about the future of the manufacturing facility and its components. The prediction server 102 may start the prediction process at a scheduled time, or in response to a predetermined event or a request from a user. In one embodiment, the prediction server 104 performs incremental updates to the predictions in-between full prediction generations. The prediction server 102 may start the prediction update upon detecting a critical event (e.g., upon receiving a notification of a critical event from a source system 104).

The prediction server 104 builds predictions by collecting data from the source systems 104, generating predictions based on the collected data, and providing the predictions to the recipient system 106. The data collected from the source systems 104 may include static data (e.g., equipment used by a source system, capability of different pieces of the equipment, etc.) and dynamic data (e.g., current state of equipment, what product is being currently processed by equipment of a source system, the characteristics of this product, etc.). The predictions generated by the prediction server 102 may specify, for example, a future state of the equipment in the manufacturing facility, the quantity and composition of the product that will be manufactured in the facility, the number of operators needed by the facility to manufacture this product, the estimated time a product will finish a given process operation and/or be available for processing at a given step, the estimated time a preventative maintenance operation should be performed on equipment, etc.

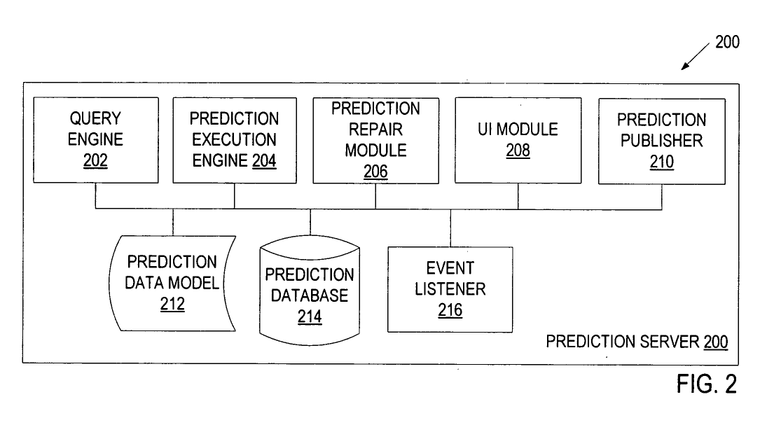

FIG. 2 is a block diagram of one embodiment of a prediction server 200. The prediction server 200 may include a query engine 202, a prediction execution engine 204, a prediction repair module 206, a user interface (UI) module 208, a prediction publisher 210, an event listener 216, a prediction data model 212, and a prediction database 214.

The prediction data model 212 defines which data is needed to create predictions. The query engine 202 submits queries to various source systems to obtain the data specified in the prediction data model 212. Upon receiving the query results from the source systems, the query engine 202 associates the received data with the prediction data model 212.

The prediction execution engine 204 uses the prediction model 212 to generate predictions. In one embodiment, the prediction execution engine 204 calculates predictions using one or more formulas. For example, the prediction execution engine 204 can make calculations using information on the process equipment that can process a lot of material, the number of pieces in the lot, and the average process time per piece. In particular, the prediction execution engine 204 can calculate the amount of processing time required on the equipment. In addition, if a lot started processing some time in the past, the prediction execution engine 204 can estimate the completion time, by knowing when processing had started.

In another embodiment, the prediction execution engine 204 runs simulation to generate predictions. In particular, the prediction execution engine 204 initializes the prediction data model 212 with the current state of the facility and information about the equipment. The equipment behavior is then simulated step by step, synchronized in time, until reaching a specific point in the future (e.g., based on a time interval provided by the user). Each transition of the product and the equipment is recorded, with the final set of data representing prediction.

In yet other embodiments, the prediction execution module 204 can generate predictions using forecasting, statistical prediction, trend analysis, or other mechanisms.

The prediction execution module 204 stores the resulting predictions in the prediction database 214. The prediction database 214 may represent any type of data storage including, for example, relational or hierarchical databases, flat files, application or shared memory, etc. The prediction publisher 210 retrieves predictions from the prediction database 214 and sends them to recipient systems. In one embodiment, the prediction publisher 210 sends predictions upon receiving a prediction request from a recipient system. In another embodiment, the prediction publisher 210 allows users or systems to subscribe for prediction services, and provides predictions to the subscribers periodically or when new predictions are generated or existing predictions are modified.

The predication repair module 206 looks for an occurrence of a critical event, and then repairs the existing predictions. The prediction repair module 206 may update the predictions stored in the prediction database 214 using simple calculations, or alternatively it may invoke the prediction execution engine 204 to generate new predictions.

The UI module 208 provides a UI allowing a user to specify desired parameters for the prediction generation process. For example, the UI may allow a user to enter a time horizon (a point of time in the future for which predictions should be generated). The user may also specify sources systems to which data queries are submitted, characteristics of the data queries, and how predictions should be generated (e.g., using simulation, forecasting, statistical prediction, trend analysis, or calculations). In addition, the user may identify entities for which prediction should be generated (e.g., equipment, product, operators, resources, etc.), and specify a trigger for initiating the prediction process (e.g., an event, a scheduled time or user request). In one embodiment, the UI module 208 also provides a UI allowing a user to specify repair parameters such as events that should cause repair, data to be obtained in response to these events, type of repair (e.g., update or regeneration), etc. In one embodiment, the UI module 208 further provides a UI allowing a subscriber of the prediction service to specify subscription preferences. For example, a subscriber may identify entities for which predictions should be generated, a time horizon for generating predictions, conditions for receiving predictions (e.g., generation of new predictions, repair of existing predictions, etc.).

The event listener 216 is responsible for sensing a trigger of the prediction operations of the prediction server 200. Such a trigger may be, for example, a user request to start the operations, a scheduled time, or a critical event occurred in the manufacturing facility.

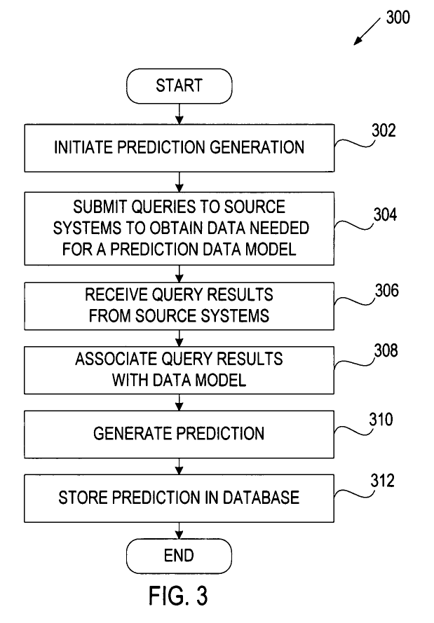

FIG. 3 is a flow diagram of one embodiment of a method 300 for providing predictions about the future of a manufacturing facility. The method may be performed by processing logic that may comprise hardware (e.g., circuitry, dedicated logic, etc.), software (such as run on a general purpose computer system or a dedicated machine), or a combination of both. In one embodiment, processing logic resides in a prediction server 102 of FIG. 1.

Referring to FIG. 3, processing logic begins with initiating prediction generation (block 302). Processing logic may initiate the prediction generation at a scheduled time or upon a user request or upon an occurrence of a predefined event.

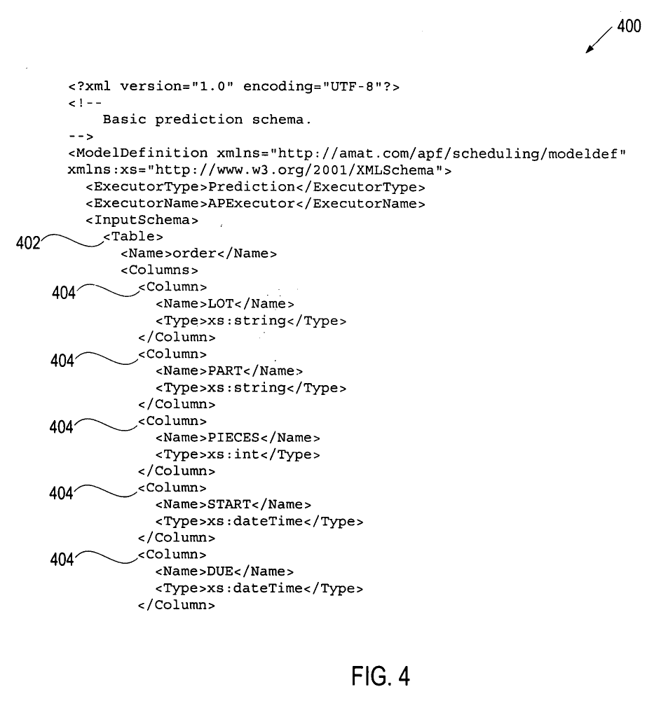

At block 304, processing logic submits queries to source systems to obtain data required for a prediction data model. A prediction data model defines a set of data needed for generating predictions. FIG. 4 illustrates a data schema 400 of an exemplary prediction data model, in accordance with one embodiment of the invention. The data schema 400 may be an XML schema or any other type of schema. The data schema 400 defines multiple tables 402 having various columns 404 to capture data needed for generating predictions.

Returning to FIG. 3, queries submitted to the source systems may be created based on type of data needed for the prediction data model. In one embodiment, the queries are created on the fly. Alternatively, the queries are predetermined for each source system used to collect data. The queries may be specified by the user or be created automatically based on data needed for the prediction data model.

At block 306, processing logic receives query results form the source systems. At block 308, processing logic puts query results in the prediction data model (i.e., populates the prediction data model).

Once building of the prediction data model is completed, processing logic generates predictions (block 310). Predictions may be generated by making calculation, forecasting, statistical prediction, trend analysis, running simulation, or using any other technique.

At block 312, processing logic stores the generated predictions in a prediction database. The prediction database may then be accessed to provide predictions to subscribers of prediction services or any other qualified recipients of prediction information. This data may be persisted in a commercial database, a custom database and/or stored in application memory.

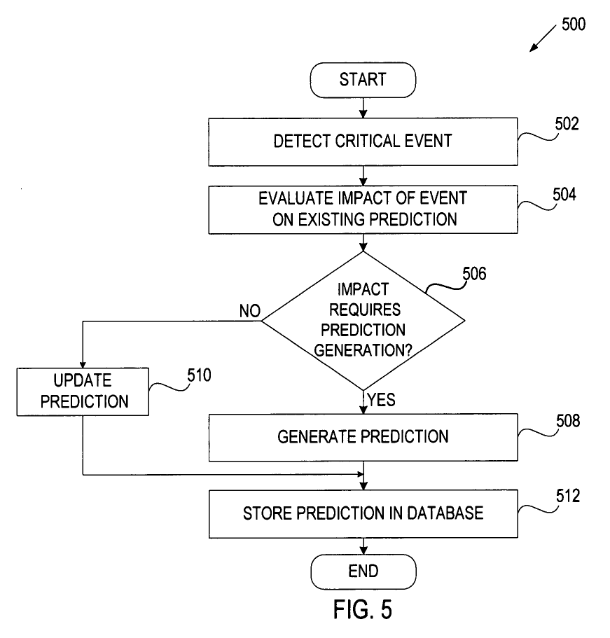

FIG. 5 is a flow diagram of one embodiment of a method 500 for repairing existing predictions. The method may be performed by processing logic that may comprise hardware (e.g., circuitry, dedicated logic, etc.), software (such as run on a general purpose computer system or a dedicated machine), or a combination of both. In one embodiment, processing logic resides in a prediction server 102 of FIG. 1.

Referring to FIG. 5, processing logic begins with detecting a critical event (block 502). The critical event may be detected upon receiving a notification from a source system. For example, a source system may be requested to provide notifications each time processing of a lot of wafers is put on hold, a piece of equipment enters a down-time state or stops functioning properly, etc.

At block 504, processing logic evaluates the impact of the critical event on the existing predictions. In one embodiment, processing logic sends a query for details regarding the critical event to the relevant source system. For example, if processing logic detects that processing of a specific lot of wafers in the MES is put on hold, processing logic may send a query to the MES to obtain all information about this lot. If the result of the query indicates that a problem which caused the interruption will be fixed during a specific time interval, processing logic may decide that complete regeneration of the existing predictions is not needed (block 506), and may repair the prediction by updating only the prediction data affected by this event (block 510) and storing the updated data in the prediction database (block 512). The update may be made using simple calculations or filters. For example, processing logic may sense that a lot has violated a time sensitive operation, and then filter the lot from the prediction result. In another example, if a piece of equipment enters a downstate, processing logic can determine when the equipment will enter a productive state and will complete processing of the respective material based on the type of the downtime event and an estimate for the repair of the equipment.

Alternatively, if the impact of the event on the current prediction is significant (e.g., it causes a change in a large portion of operations to be performed), processing logic regenerates predictions using simulation or calculations (block 508), and stores the new predictions in the prediction database (block 512).

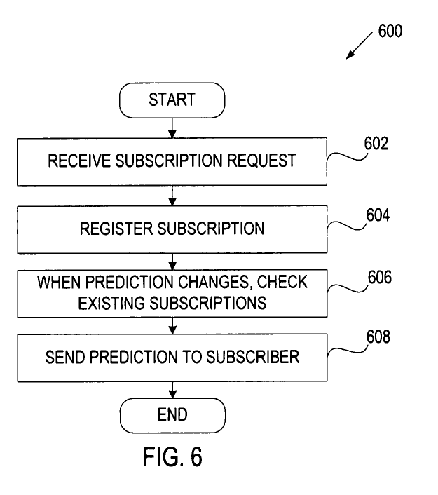

FIG. 6 is a flow diagram of one embodiment of a method 600 for providing subscription services to subscribers. The method may be performed by processing logic that may comprise hardware (e.g., circuitry, dedicated logic, etc.), software (such as run on a general purpose computer system or a dedicated machine), or a combination of both. In one embodiment, processing logic resides in a prediction server 102 of FIG. 1.

Referring to FIG. 6, processing logic begins with receiving a request to subscribe for prediction services (block 602). The request may include parameters for generating predictions (e.g., time horizon, entities of interest such as equipment or product, etc.). At block 604, processing logic registers the subscription request in a subscription database. Subsequently, when prediction changes (e.g., due to repair or generation of new prediction), processing logic checks existing subscriptions to find subscribes interested in the new prediction (block 606) and sends the new prediction to those subscribers (block 608). It should be noted that blocks 606 and 608 can be repeated multiple times in response to prediction updates, while blocks 602 and 604 may be performed only once per subscription.

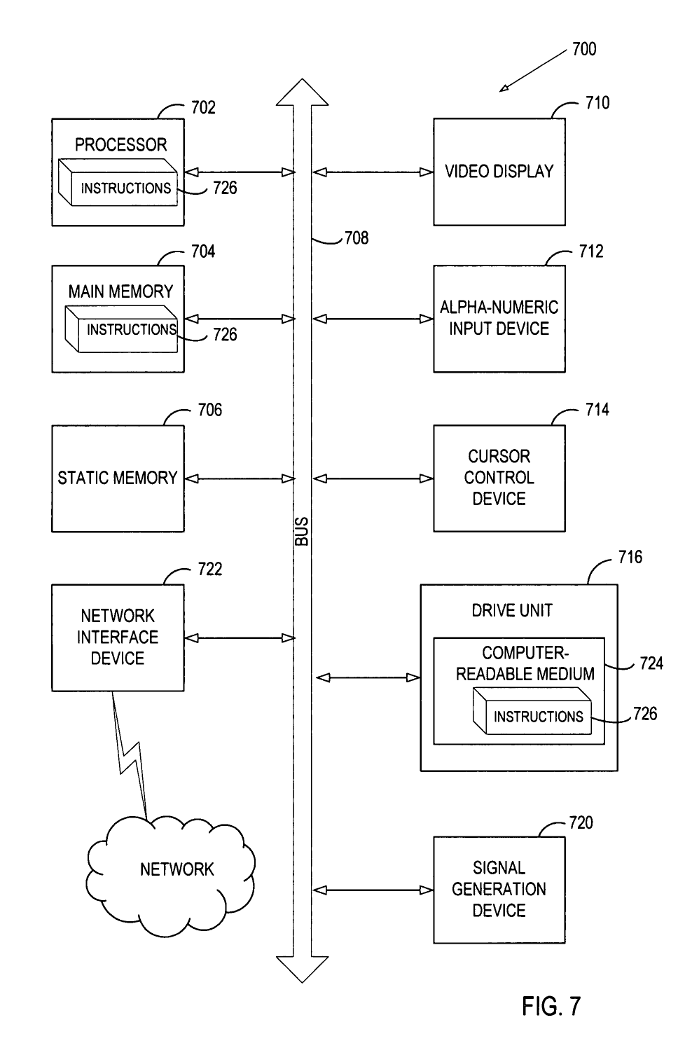

FIG. 7 illustrates a diagrammatic representation of a machine in the exemplary form of a computer system 700 within which a set of instructions, for causing the machine to perform any one or more of the methodologies discussed herein, may be executed. The machine may be connected (e.g., networked) to other machines in a LAN, an intranet, an extranet, or the Internet. The machine may operate in a client-server network environment, or as a peer machine in a peer-to-peer (or distributed) network environment. While only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device (processor) 702, a main memory 704 (e.g., read-only memory (ROM), flash memory, dynamic random access memory (DRAM) such as synchronous DRAM (SDRAM) or Rambus DRAM (RDRAM), etc.), and a static memory 706 (e.g., flash memory, static random access memory (SRAM), etc.), which may communicate with each other via a bus 730. Alternatively, the processing device 702 may be connected to memory 704 and/or 706 directly or via some other connectivity means.

Processing device 702 represents one or more general-purpose processing devices such as a microprocessor, central processing unit, or the like. More particularly, the processing device 702 may be complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 702 is configured to execute processing logic 726 for performing the operations and steps discussed herein.

The computer system 700 may further include a network interface device 708 and/or a signal generation device 716. It also may or may not include a video display unit (e.g., a liquid crystal display (LCD) or a cathode ray tube (CRT)), an alphanumeric input device (e.g., a keyboard), and/or a cursor control device (e.g., a mouse).

The computer system 700 may or may not include a secondary memory 718 (e.g., a data storage device) having a machine-accessible storage medium 731 on which is stored one or more sets of instructions (e.g., software 722) embodying any one or more of the methodologies or functions described herein. The software 722 may also reside, completely or at least partially, within the main memory 704 and/or within the processing device 702 during execution thereof by the computer system 700, the main memory 704 and the processing device 702 also constituting machine-accessible storage media. The software 722 may further be transmitted or received over a network 720 via the network interface device 708.

While the machine-accessible storage medium 731 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A computerized method comprising:
receiving data from a plurality of source systems in a manufacturing facility;
generating predictions pertaining to a future state of the manufacturing facility based on the data received from the plurality of source systems; and
providing the predictions to a plurality of recipient systems in the manufacturing facility.

2. The method of claim 1 wherein:
the plurality of source systems comprises at least one of a manufacturing execution system (MES), a maintenance management system (MMS), a material control system (MCS), an equipment control system (ECS), or an inventory control system (ICS); and
the plurality of recipient systems comprises at least one of the MES, the MMS, the MCS, the ECS, the ICS, a dispatcher, or a scheduler.

3. The method of claim 1 wherein the predictions pertaining to the future state of the manufacturing facility include information about at least one of a future state of equipment in the facility, a composition of lots to be manufactured, a number of lots to be manufactured, a number of operators needed by the facility, an estimated time a product will finish a given process operation or be available for processing at a given step, an estimated time a preventative maintenance operation should be performed on equipment.

4. The method of claim 1 wherein receiving data from the plurality of source systems comprises:
submitting queries to the plurality of source systems to obtain data needed for a prediction data model;
receiving query results from the plurality of source systems; and
associating the query results with the prediction data model.

5. The method of claim 1 wherein providing the predictions to the plurality of recipient systems comprises:
storing the predictions in a database; and
sending the predictions retrieved from the database to at least one of the plurality of recipient systems.

6. The method of claim 5 wherein the predictions are sent upon receiving a request from at the least one of the plurality of recipient systems.

7. The method of claim 5 further comprising:
receiving a request to subscribe to predictions from the least one of the plurality of recipient systems, the request specifying prediction parameters; and
sending the predictions to subscribers periodically or upon a change in the predictions.

8. The method of claim 1 wherein the predictions are generated using at least one of simulation, forecasting, statistical prediction, trend analysis, or calculation.

9. The method of claim 4 further comprising:
receiving prediction properties from a user, the prediction properties identifying at least one of a time horizon, the plurality of source systems, query parameters, entities being predicted, a trigger of prediction generation, or a method of prediction generation.

10. The method of claim 1 further comprising:
incrementally updating the predictions.

11. The method of claim 9 wherein incrementally updating the predictions comprises:
detecting a predefined event;
evaluating an impact of the event on existing predictions; and
updating the existing predictions or generating new predictions depending on the impact.

12. A computer-readable medium having executable instructions to cause a computer system to perform a method comprising:
receiving data from a plurality of source systems in a manufacturing facility;
generating predictions pertaining to a future state of the manufacturing facility based on the data received from the plurality of source systems; and
providing the predictions to a plurality of recipient systems in the manufacturing facility.

13. The computer-readable medium of claim 12 wherein:
the plurality of source systems comprises at least one of a manufacturing execution system (MES), a maintenance management system (MMS), a material control system (MCS), an equipment control system (ECS), an inventory control system (ICS; and
the plurality of recipient systems comprises at least one of the MES, the MMS, the MCS, the ECS, the ICS, a dispatcher, or a scheduler.

14. The computer-readable medium of claim 12 wherein the predictions pertaining to the future state of the manufacturing facility include information about at least one of a future state of equipment in the facility, a composition of lots to be manufactured, a number of lots to be manufactured, a number of operators needed by the facility, an estimated time a product will finish a given process operation or be available for processing at a given step, an estimated time a preventative maintenance operation should be performed on equipment.

15. The computer-readable medium of claim 12 wherein receiving data from the plurality of source systems comprises:
submitting queries to the plurality of source systems to obtain data needed for a prediction data model;
receiving query results from the plurality of source systems; and
associating the query results with the prediction data model.

16. The computer-readable medium of claim 12 wherein the predictions are generated using at least one of simulation, forecasting, statistical prediction, trend analysis, or calculation.

17. The computer-readable medium of claim 12 wherein the method further comprises:
incrementally updating the predictions, the incremental update comprising evaluating an impact of the event on existing predictions, and updating the existing predictions or generating new predictions depending on the impact.

18. An apparatus comprising:
a query engine to receive data from a plurality of source systems in a manufacturing facility;
a prediction execution engine, coupled to the query engine, to generate predictions pertaining to a future state of the manufacturing facility based on the data received from the plurality of source systems;
a prediction database, coupled to the prediction execution engine, to store the predictions; and
a prediction publisher, coupled to the prediction database, to retrieve the predictions from the database and to provide the predictions to a plurality of recipient systems in the manufacturing facility.

19. The apparatus of claim 18 wherein:
the plurality of source systems comprises at least one of a manufacturing execution system (MES), a maintenance management system (MMS), a material control system (MCS), an equipment control system (ECS), or an inventory control system (ICS); and
the plurality of recipient systems comprises at least one of the MES, the MMS, the MCS, the ECS, the ICS, a dispatcher, or a scheduler.

20. The apparatus of claim 18 wherein the predictions pertaining to the future state of the manufacturing facility include information about at least one of a future state of equipment in the facility, a composition of lots to be manufactured, a number of lots to be manufactured, a number of operators needed by the facility, an estimated time a product will finish a given process operation or be available for processing at a given step, an estimated time a preventative maintenance operation should be performed on equipment.

21. The apparatus of claim 18 wherein the query engine is to receive data from the plurality of source systems by
submitting queries to the plurality of source systems to obtain data needed for a prediction data model,
receiving query results from the plurality of source systems, and
associating the query results with the prediction data model.

22. The apparatus of claim 18 wherein the prediction execution engine is to generate the predictions using at least one of simulation, forecasting, statistical prediction, trend analysis, or calculation.

23. The apparatus of claim 21 further comprising:
a user interface module to receive prediction properties from a user, the prediction properties identifying at least one of a time horizon, the plurality of source systems, query parameters, entities being predicted, a trigger of prediction generation, or a method of prediction generation.

24. The apparatus of claim 18 further comprising a prediction repair module to incrementally update the predictions by
detecting a predefined event,
evaluating an impact of the event on existing predictions, and
updating the existing predictions or generating new predictions depending on the impact.
